(19) United States
(12) Patent Application Publication
(10) Pub. No.: US 2021/0291619 A1
(43) Pub. Date: Sep. 23, 2021

(54) THERMAL COMFORT MODEL (TCM) BASED CLIMATE CONTROL STRATEGY USING EQUIVALENT TEMPERATURE

(71) Applicant: NIO USA, Inc., San Jose, CA (US)

(72) Inventors: Sama Aghniaey, San Jose, CA (US); An Wu, San Jose, CA (US); Joshua Smith, Los Gatos, CA (US); Bruno M. Barthelemy, Los Gatos, CA (US); Anqi Wang, San Jose, CA (US)

(21) Appl. No.: 16/822,414

(22) Filed: Mar. 18, 2020

(51) Int. Cl. B60H 1/00; B60W 10/30; B60W 40/08; B60W 50/00; B60W 50/10

(52) U.S. Cl. CPC B60H 1/00807; B60W 10/30; B60H 2001/00942; B60W 50/0098; B60W 50/10; B60W 40/08

(57) ABSTRACT

Embodiments include a method for controlling a thermal environment inside of a vehicle, the method comprising: determining, by a processor of a climate control system of the vehicle, a plurality of factors influencing the thermal environment inside of the vehicle; calculating, by the processor of the climate control system, an equivalent temperature for each of a plurality of zones inside of the vehicle based on the plurality of factors, each equivalent temperature comprising an indication of a user's perception of the thermal environment at each of the plurality of zones inside of the vehicle; and controlling, by the processor of the climate control system, a Heating, Ventilation, and Air Conditioning (HVAC) system of the vehicle based on the calculated equivalent temperatures for each of the plurality of zones inside of the vehicle.

### FIELD

The present disclosure is generally directed to vehicle climate control systems and in particular toward vehicle climate control using a thermal comfort model based on an equivalent temperature rather than absolute dry bulb temperature.

### BACKGROUND

User thermal comfort in car cabins has been a very important aspect of user comfort and user experience especially in electric and autonomous vehicles. To facilitate autonomous driving, almost all functions of a vehicle should be automated, as much as possible. Currently, user thermal comfort in vehicles is being controlled by cabin air temperature using feedback from one or two in-cabin air temperature sensors. Users can adjust the Heating, Ventilating, and Air Conditioning (HVAC) system settings and change the thermal environment in cabin using manually adjustable air temperature (relative or absolute) and blower level set points. However, a thermal environment that a person is exposed to is a factor of different environmental and personal parameters and air temperature is only one of them. User thermal comfort, especially in a vehicle, is substantially influenced by a variety of environmental parameters beyond air temperature and air speed, most importantly by solar flux and hot/cold surfaces (mean radiant temperature) in the cabin. A users' clothing level and metabolic rate are among other significant parameters affecting user thermal comfort in a cabin. Therefore, air temperature sampled from one or two locations in cabin cannot represent a thermal environment and how passengers perceive that thermal environment.

However, traditionally, in car cabins, air temperature values are being measured and controlled as the indicator of in-cabin thermal environment and user thermal comfort. This trivial control strategy renders the user in charge of continuously adjusting the HVAC setting to make her/himself comfortable (highly user-assisted thermal control). One major issue in cabin thermal comfort control is the radiant heat transfer between the hot or cold surfaces and human body and also the impact of direct solar radiation on human body in an open space or a transparent enclosure like a car cabin. This radiation heat transfer cannot be quantified through measuring air temperature and the radiation heat transfer is not currently controlled and compensated for in a car cabin. Hence, there is a need in the art for improved methods and systems for vehicle climate control.

### BRIEF DESCRIPTION OF THE DRAWINGS

FIG. 1 illustrates a view of a vehicle in which embodiments of the present disclosure may be implemented.

FIG. 2 is a block diagram illustrating elements of an exemplary climate control system for a vehicle according to one embodiment of the present disclosure.

FIG. 3 is a block diagram illustrating additional details of a climate control system according to one embodiment of the present disclosure.

FIG. 4 is a flowchart illustrating an exemplary process for climate control in a vehicle according to one embodiment of the present disclosure.

### DETAILED DESCRIPTION

Embodiments of the present disclosure will be described in connection with a vehicle, and in some embodiments, an electric vehicle, rechargeable electric vehicle, and/or hybrid-electric vehicle and associated systems.

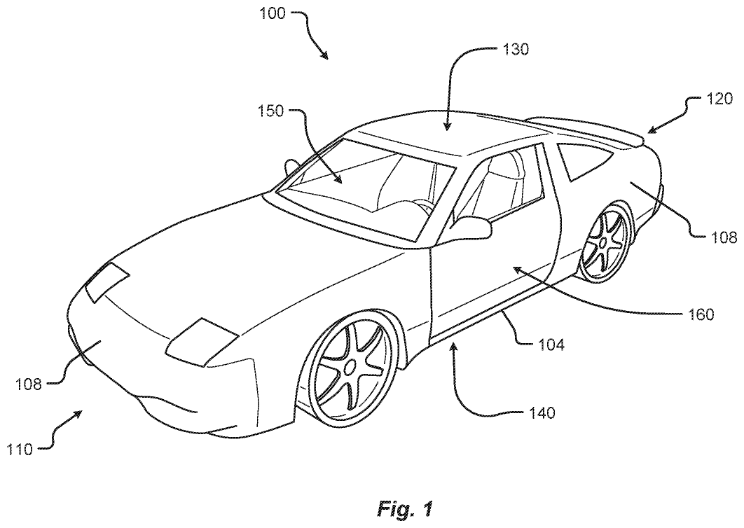

FIG. 1 shows a perspective view of a vehicle 100 in accordance with embodiments of the present disclosure. The electric vehicle 100 comprises a vehicle front 110, vehicle aft 120, vehicle roof 130, at least one vehicle side 160, a vehicle undercarriage 140, and a vehicle interior 150. In any event, the vehicle 100 may include a frame 104 and one or more body panels 108 mounted or affixed thereto. The vehicle 100 may include one or more interior components (e.g., components inside an interior space 150, or user space, of a vehicle 100, etc.), exterior components (e.g., components outside of the interior space 150, or user space, of a vehicle 100, etc.), drive systems, controls systems, structural components, etc.

Although shown in the form of a car, it should be appreciated that the vehicle 100 described herein may include any conveyance or model of a conveyance, where the conveyance was designed for the purpose of moving one or more tangible objects, such as people, animals, cargo, and the like. The term “vehicle” does not require that a conveyance moves or is capable of movement. Typical vehicles may include but are in no way limited to cars, trucks, motorcycles, busses, automobiles, trains, railed conveyances, boats, ships, marine conveyances, submarine conveyances, airplanes, space craft, flying machines, human-powered conveyances, and the like.

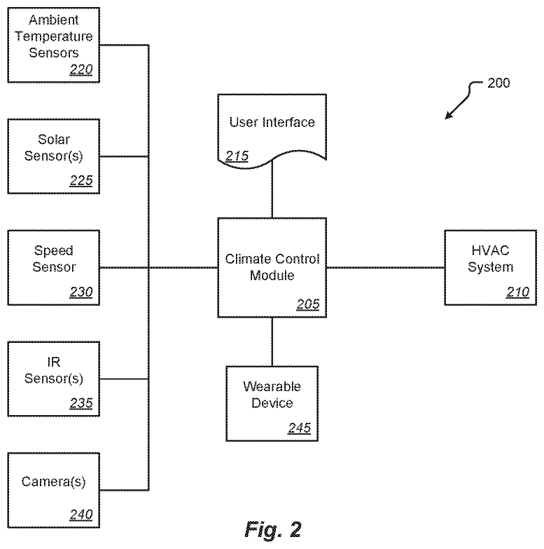

FIG. 2 is a block diagram illustrating elements of an exemplary climate control system for a vehicle according to one embodiment of the present disclosure. As illustrated in this example, a climate control system 200 of a vehicle 100 can comprise a climate control module 205 which controls a Heating Ventilating and Air Conditioning (HVAC) system of the vehicle 100 including, but not limited to one or more heaters, an air conditioning system, one or more blowers, louvers of an air duct system, etc. Generally speaking, the climate control module 205 can control these elements of the HVAC system 210 to regulate a thermal environment inside of the vehicle 100. This control can be based on input from a user interface 215 and any number of sensors. As will be described in greater detail below, these sensors can include, but are not limited to, a plurality of ambient temperature sensors 220, one or more mean 225, a vehicle speed sensor 2320, one or more IR sensors 235, and/or one or more cameras 240. In some cases, and as will be described below, the climate control module 205 may also be communicatively coupled with and receive input from a wearable device 245 of one or more users of the vehicle 100.

According to one embodiment, a thermal environment that is a combination of various thermal environmental and personal factors can be represented by an “equivalent temperature” rather than the typical dry bulb temperature. Equivalent temperature can be defined as:

$${T}_{e q} = 0.55 {t}_{a} + 0.45 {t}_{r} + \frac{0.24 - 0.75 \sqrt{{v}_{a}}}{1 + {I}_{c l}} ( 36.5 - {t}_{a} )$$

Where T_{eq} (° C.) is the equivalent temperature, tₐ (° C.) is the air or dry bulb temperature as measured, for example, by the plurality of ambient temperature sensors 220, Tᵣ (° C.) is the mean radiant temperature as calculated using one or more solar sensors 225, vₐ (m/s) is the air speed as determined based on input from one or more fan speed 230, and I_{cl} (clo where 1 clo equals 0.155 m² K/W) is the clothing insulation of passengers measured by a clothing detection device or estimated based on the outdoor environmental conditions, and cultural and demographic factors for each region. Mean radiant temperature represents the radiation heat transfer between the passenger and the surrounding environment and includes the impact of direct solar radiation and radiation heat transfer between the passenger and the surrounding hot and cold surfaces.

The main purpose of the HVAC system 210 is to provide a comfortable and healthy thermal environment and fresh and clean air to passengers in the cabin of the vehicle 100. This will improve the user experience and satisfaction, and their safety as the driver can stay alert and focused in a comfortable thermal environment with a sufficient amount of high-quality fresh air. According to one embodiment, a granular thermal comfort model (TCM) can be used to control the cabin climate. A thermal comfort model can correlate the equivalent temperature to a user thermal sensation in different body parts. The climate control module 205, implementing such a TCM can control the HVAC system 210 based on the equivalent temperature instead of controlling the air (dry bulb) temperature at one or two locations in cabin. In this way, the TCM provides a holistic control of the thermal environment based on the passenger or user's thermal sensation or thermal comfort.

A TCM-based climate control system 200 provides for a simplified HVAC adjustment and user feedback system based on the users' thermal comfort or preferences. This can substantially decrease the users' amount of interactions with the HVAC system and help the driver to remain focused on the road. This can also improve the convenience of the feedback system since the user only needs to tell the system if he/she feels thermally a certain way or would rather certain changes be made and the user will not have to deal with continuous adjustment of the HVAC temperature and blower level settings. Generally speaking, thermal perception is relative to the current situation while a temperature value is absolute and air temperature value of a certain level, e.g., 25° C., is always the same and could cause different thermal comfort levels based on the other thermal environmental factors. Embodiments described herein provide a system that will allow the user to make changes relative to the current thermal conditions in the cabin, e.g., make it warmer or cooler, instead of making absolute changes such as setting the temperature to a certain level, e.g., 23° C., that might feel comfortable in some occasion and feel uncomfortable in other situations depending on the equivalent temperature. The SCC system uses TCM to decide what changes to make to the thermal environment to satisfy the user.

Once a user stops adjusting the climate control system 300 system, the climate control module 205 can maintain that equivalent temperature or thermal sensation around the user. If any changes happen in the thermal environment during the ride, for example solar flux changes or the user changes his/her clothing level, the climate control module 205 can change the HVAC system 210 to maintain the equivalent temperature or thermal sensation associated with user's comfortable conditions.

According to one embodiment, the user interface 215, such as may be provided by the climate control module 205 through a display on the dashboard of the vehicle 100, can provide simplified controls for influencing the thermal environment in relative terms rather than in terms of an absolute temperature value. For example, when passengers feel thermally uncomfortable, they know if they feel cold or warm, but they do not necessarily know how to change the HVAC setting to achieve thermal comfort. Typically, they have to adjust the AC setting continuously to reach the sweet spot that makes them feel comfortable. Then, any changes in the environment, such as solar flux, will cause thermal discomfort again and user will have to adjust the AC system repeatedly. Embodiments descried herein provide a thermal-preference-based user interface 215 that simplifies a user's interaction with the climate control system 300. For example, a user can ask the system 300 to make the cabin environment cooler or warmer through pushing a cooler or warmer button in the user interface multiple times as needed or through choosing her/his preference through voice commands or pushing buttons such as “Much Colder,” “Colder,” “Slightly Cooler,” “Slightly Warmer,” “Hotter,” “Much Hotter,” etc. Additionally, or alternatively, the user can indicate that he or she feels “Too Cold,” “Cold,” “Slightly Cool,” “Slightly Warm,” “Hot,” “Too Hot,” etc. The climate control module 205 can then calculate the current equivalent temperature and the target equivalent temperature using the feedback from the user and will make appropriate changes to the HVAC system 210 to make the user comfortable.

Embodiments described herein provide a dynamic system where a TCM can be embedded in the climate control module 205. Every time users adjust the climate control system 200, the current equivalent temperature can be calculated based on the current conditions and the user's feedback. So, changes can be made relative to the current conditions in this system and changes can be made according to the user's thermal sensation in a holistic and strategic way using the equivalent temperature.

A thermal environment in a vehicle cabin is highly transient and is prone to continuous changes with any changes in any of parameters affecting user thermal comfort. One of the major problems with current HVAC control systems is the need for continuous adjustment of HVAC system setting to compensate for any changes in thermal environmental conditions such as solar flux or sun position relative to the vehicle, outdoor ambient conditions, user clothing, etc. Traditional control systems only respond to changes in air temperature at one or two points in cabin where air temperature sensors are located. However, what affects passenger thermal comfort is a myriad of factors and air temperature is only one of them. With one constant air temperature in the cabin, users can experience different thermal environmental conditions and comfort level. Embodiments described herein maintain the equivalent temperature in the cabin instead of the air temperature and respond to changes in various thermal environmental parameters through changing the HVAC setting continuously. So, passengers might experience different air temperature setpoints or air flow rates during the ride but their thermal comfort and the equivalent temperature in cabin remains constant. Since passenger's thermal comfort is directly related to equivalent temperature, this control strategy can provide autonomous and touchless thermal comfort control with minimum effort and user interaction.

According to one embodiment, the climate control module 205 can implement or integrate with a behavior learning module (not shown here) and enable learning of thermal preferences of different users based on their preferred thermal sensation and associated equivalent temperature over time. Thus, whenever a user enters the car, the smart climate control system can identify the user and provide the user-preferred thermal environment in any combination of thermal environmental and personal conditions. This can substantially reduce the cost and memory associated with data storage and data analysis, and the complexity of the personal profiles stored in the system for each user regarding their thermal comfort.

According to one embodiment, a thermal comfort model based on equivalent temperature can be developed based on data collected at least from in-car air temperature sensor(s) and/or ambient temperature sensor 220, solar sensors or solar sensors 225, supply air flow rate sensor, vehicle speed sensors 230, and clothing detection sensor if available, using machine learning techniques. The equivalent temperature in a plurality of different passenger zones, e.g., head zone, torso zone, and feet zone, can be estimated and the corresponding local thermal sensation can be identified and controlled.

According to one embodiment, the climate control module 205 can be connected to a wearable device 245 of a user of the vehicle such as a watch that could transfer the user's biophysical conditions such as heart rate, breathe rate, and skin temperature to the climate control module 205. This can be used by the climate control module 205 to monitor the user's thermal stress in real time and control the user's comfort throughout the ride.

Additionally, or alternatively, one or more IR (far infrared) sensors 235 can be mounted in the vehicle to monitor the temperature of different surfaces in the cabin, e.g., door trim, windows, windshield, dashboard, etc., in real time. This can be used by the climate control module 205 to better predict the mean radiant temperature or the temperature for hot/cold surfaces near users and to increase accuracy. In some cases, IR sensor(s) 235 can additionally or alternatively be mounted in the cabin to monitor the user's skin temperature in real time. The climate control module 205 can then predict the user's thermal sensation through monitoring the user's skin temperature and adjusting the HVAC system 210 to make the user comfortable. The same, or other, IR sensors 235 could be used for clothing detection and/or detecting breath rate and heart rate of the user for thermal stress and health status monitoring.

According to one embodiment, a camera 240 can additionally or alternatively be integrated into the climate control system 200. In such cases, the camera 240 can be used by the climate control module 205 to detects users' clothing, e.g., using image processing tools as known in the art. The climate control module 205 can then use this to set the clothing insulation factor used to calculate the equivalent temperature as described above and adjust the HVAC system 210 based on resulting equivalent temperature.

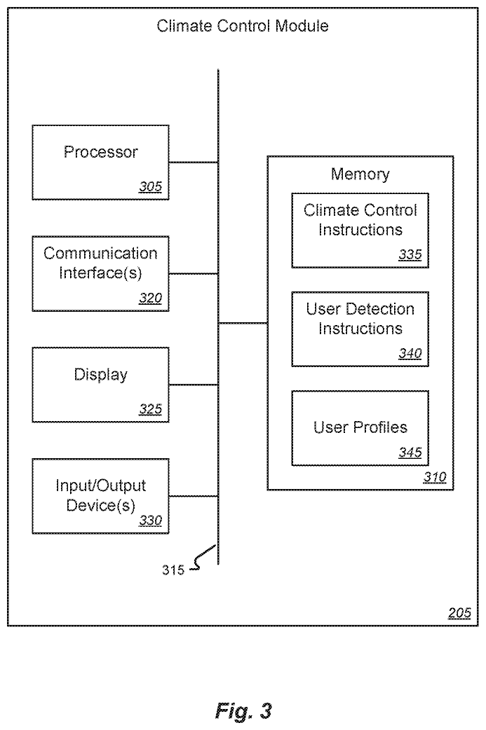

FIG. 3 is a block diagram illustrating additional details of a climate control system according to one embodiment of the present disclosure. As illustrated in this example, a climate control module 205 can comprise a processor 305. The processor 305 may correspond to one or many computer processing devices. For instance, the processor 305 may be provided as silicon, as a Field Programmable Gate Array (FPGA), an Application-Specific Integrated Circuit (ASIC), any other type of Integrated Circuit (IC) chip, a collection of IC chips, or the like. As a more specific example, the processor 305 may be provided as a microprocessor, Central Processing Unit (CPU), or plurality of microprocessors that are configured to execute the instructions sets stored in a memory 310. Upon executing the instruction sets stored in memory 310, the processor 305 enables various functions of the climate control module 205 as described herein.

A memory 310 can be coupled with and readable by the processor 305 via a communications bus 315. The memory 310 may include any type of computer memory device or collection of computer memory devices. Non-limiting examples of memory 310 include Random Access Memory (RAM), Read Only Memory (ROM), flash memory, Electronically-Erasable Programmable ROM (EEPROM), Dynamic RAM (DRAM), etc. The memory 310 may be configured to store the instruction sets depicted in addition to temporarily storing data for the processor 305 to execute various types of routines or functions.

The processor 305 can also be coupled with one or more communication interfaces 320 and a display 325 via the communications bus 315. The communication interfaces 320 can comprise, for example, a Bluetooth, WiFi, or other type of wireless communications interface, for example for communicating with wearable and/or mobile devices of the users within the vehicle. In some cases, the communication interfaces 320 can also include an interface for communicating via a wireless network. The display 325 can comprise, for example, a Liquid Crystal Display (LCD), Light Emitting Diode (LED), Organic Light Emitting Diode (OLED), Plasma Display Panel (PDP), Cathode Ray Tube (CRT) display or other type of display for presenting a climate control user interface 215 as described above. Any number of input/output devices 330, including, but not limited to, the ambient temperature sensors 220, solar sensor(s) 225, speed sensor 230, IR sensor(s) 235, and/or camera(s) 340 can also be coupled with the communications bus 315.

The memory 310 can store therein sets of instructions which, when executed by the processor 305, cause the processor 305 to control an HVAC system 210 of a vehicle 100 as described herein. More specifically, the memory 310 can store a set of user detection instructions 340 which can, when executed by the processor 305, cause the processor 305 to identify a user of the vehicle 100. As noted above, the user can be identified using face recognition of an image from a camera, voice recognition on audio from a microphone, biometric information from one or more sensors in the vehicle 100, based on a wearable device worn by the user or a mobile device carried by the user, etc.

The memory can also store therein a set of climate control instructions 335 which, when executed by the processor 305, cause the processor 305 to determine a plurality of factors influencing the thermal environment inside of the vehicle. For example, determining the plurality of factors can comprise determining an ambient temperature inside of the vehicle measured at each of a plurality of locations within the vehicle and an ambient temperature outside of the vehicle. Determining the plurality of factors can additionally or alternatively comprise determining a radiant temperature measured on one or more surfaces on the inside of the vehicle, e.g., using one or more IR sensors. Additionally, or alternatively, determining the plurality of factors can comprise determining a velocity of the vehicle. In some cases, a clothing insulation factor can also be determined for the user based on an image from a camera inside the vehicle, an IR signature of the user from an IR sensor, based on a predetermined value which can be adjusted based on time of year, etc.

The climate control instructions 335 can further cause the processor 305 to calculate an equivalent temperature for each of a plurality of zones inside of the vehicle based on the plurality of factors. Each equivalent temperature can comprise an indication of a user's perception of the thermal environment at each of the plurality of zones inside of the vehicle. The calculated equivalent temperature and the plurality of factors upon which it is based can be saved in a user profile 345 for the identified user also saved in memory 310. The climate control instructions 335 can the cause processor 305 to control the HVAC system 210 of the vehicle 100 based on the calculated equivalent temperatures for each of the plurality of zones inside of the vehicle 100.

While the HVAC system is being controlled based on the calculated equivalent temperature, the climate control instructions 335 can cause the processor 305 to detect a request to change the thermal environment inside the vehicle. The request can comprise feedback on the calculated equivalent temperature in relative terms, e.g., “too hot” or “too cold,” or a change to the calculated equivalent temperature in relative terms, e.g., “increase temperature” or “decrease temperature.” In response, the climate control instructions 335 can cause the processor 305 to calculate a new equivalent temperature for each of the plurality of zones inside of the vehicle 100 based on current values for the plurality of factors and the request to change the thermal environment inside the vehicle. The climate control instructions 335 can also cause the processor 305 to update the profile 445 for the identified user with the new equivalent temperatures and the current values for the plurality of factors upon which it is based and control the HVAC system 210 of the vehicle 100 based on the calculated new equivalent temperatures for each of the plurality of zones inside of the vehicle.

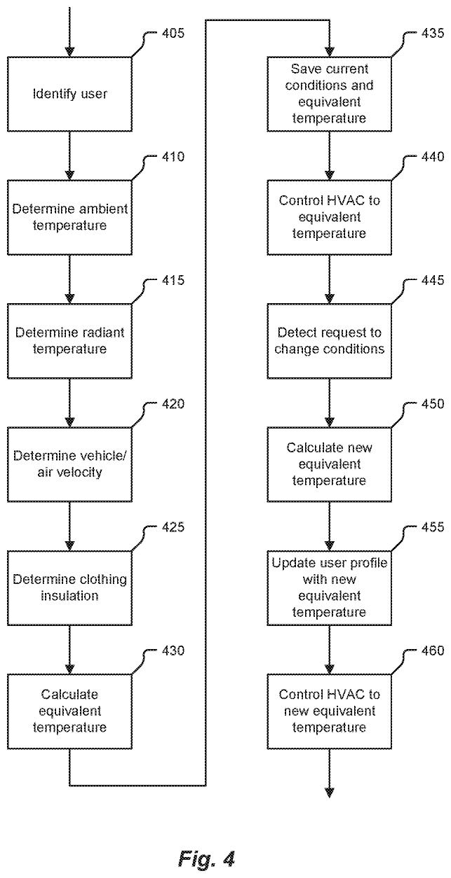

FIG. 4 is a flowchart illustrating an exemplary process for climate control in a vehicle according to one embodiment of the present disclosure. As illustrated in this example, controlling a thermal environment inside of a vehicle can comprise identifying 405 a user of the vehicle 100. As noted above, the user can be identified using face recognition of an image from a camera, voice recognition from on audio from a camera or NOMI device (NOMI is like Alexa specific to NIO cars), biometric information from one or more sensors in the vehicle 100, based on a wearable device worn by the user or a mobile device carried by the user, etc.

A plurality of factors influencing the thermal environment inside of the vehicle can be determined. For example, determining the plurality of factors can comprise determining 410 an ambient temperature inside of the vehicle measured at each of a plurality of locations within the vehicle and an ambient temperature outside of the vehicle. Determining the plurality of factors can additionally or alternatively comprise determining 415 a radiant temperature measured on one or more surfaces on the inside of the vehicle, e.g., using one or more IR sensors. Additionally, or alternatively, determining the plurality of factors can comprise determining 420 the velocity of the vehicle. In some cases, a clothing insulation factor can also be determined for the user based on an image from a camera inside the vehicle, an IR signature of the user from an IR sensor, based on a predetermined value which can be adjusted based on time of year, etc.

An equivalent temperature can be calculated 430 for each of a plurality of zones inside of the vehicle based on the plurality of factors. Each equivalent temperature can comprise an indication of a user's perception of the thermal environment at each of the plurality of zones inside of the vehicle. The calculated equivalent temperature and the plurality of factors upon which it is based can be saved 435 in the profile for the identified user and the HVAC system 210 of the vehicle 100 can be controlled 440 based on the calculated equivalent temperatures for each of the plurality of zones inside of the vehicle 100.

While the HVAC system is being controlled 440 based on the calculated 430 equivalent temperature, a request to change the thermal environment inside the vehicle can be detected 445. The request comprising feedback on the calculated equivalent temperature in relative terms, e.g., “too hot” or “too cold,” or a change to the calculated equivalent temperature in relative terms, e.g., “increase temperature” or “decrease temperature.” In response, a new equivalent temperature for each of the plurality of zones inside of the vehicle 100 can be calculated 450 based on current values for the plurality of factors and the request to change the thermal environment inside the vehicle. The profile for the identified user can be updated 455 with the new equivalent temperatures and the current values for the plurality of factors upon which it is based. The HVAC system of the vehicle can then be controlled 460 based on the calculated new equivalent temperatures for each of the plurality of zones inside of the vehicle.

Embodiments include a method for controlling a thermal environment inside of a vehicle, the method comprising: determining, by a processor of a climate control system of the vehicle, a plurality of factors influencing the thermal environment inside of the vehicle; calculating, by the processor of the climate control system, an equivalent temperature for each of a plurality of zones inside of the vehicle based on the plurality of factors, each equivalent temperature comprising an indication of a user's perception of the thermal environment at each of the plurality of zones inside of the vehicle; and controlling, by the processor of the climate control system, a Heating, Ventilation, and Air Conditioning (HVAC) system of the vehicle based on the calculated equivalent temperatures for each of the plurality of zones inside of the vehicle.

Aspects of the above method include wherein the plurality of factors comprises an ambient temperature inside of the vehicle measured at each of a plurality of locations within the vehicle and an ambient temperature outside of the vehicle.

Aspects of the above method include wherein the plurality of factors comprises a radiant temperature measured on one or more surfaces on the inside of the vehicle.

Aspects of the above method include wherein the plurality of factors comprises a velocity of the vehicle.

Aspects of the above method further include determining a clothing insulation factor for the user and wherein calculating the equivalent temperature for each of the plurality of zones inside of the vehicle is further based on the clothing insulation factor.

Aspects of the above method further include: detecting, by the processor of the climate control system, a request to change the thermal environment inside the vehicle, the request comprising feedback on the calculated equivalent temperature in relative terms or a change to the calculated equivalent temperature in relative terms; calculating, by the processor of the climate control system, a new equivalent temperature for each of the plurality of zones inside of the vehicle based on current values for the plurality of factors and the request to change the thermal environment inside the vehicle; and controlling, by the processor of the climate control system, the HVAC system of the vehicle based on the calculated new equivalent temperatures for each of the plurality of zones inside of the vehicle.

Aspects of the above method further include identifying, by the processor of the climate control system, the user and wherein calculating the equivalent temperature for each of the plurality of zones inside of the vehicle is based on a profile for the identified user.

Aspects of the above method further include: saving, by the processor of the climate control system, the calculated equivalent temperature and the plurality of factors upon which it is based in the profile for the identified user; and updating, by the processor of the climate control system, the profile for the identified user with the new equivalent temperatures and the current values for the plurality of factors upon which it is based.

Embodiments include a climate control system of a vehicle, the climate control system comprising: a processor; and a memory, coupled with and readable by the processor and storing therein a set of instructions which, when executed by the processor, cause the processor to control a thermal environment inside the vehicle by: determining a plurality of factors influencing the thermal environment inside of the vehicle; calculating an equivalent temperature for each of a plurality of zones inside of the vehicle based on the plurality of factors, each equivalent temperature comprising an indication of a user's perception of the thermal environment at each of the plurality of zones inside of the vehicle; and controlling a Heating, Ventilation, and Air Conditioning (HVAC) system of the vehicle based on the calculated equivalent temperatures for each of the plurality of zones inside of the vehicle.

Aspects of the above climate control system include wherein the plurality of factors comprises an ambient temperature inside of the vehicle measured at each of a plurality of locations within the vehicle and an ambient temperature outside of the vehicle.

Aspects of the above climate control system include wherein the plurality of factors comprises a radiant temperature measured on one or more surfaces on the inside of the vehicle.

Aspects of the above climate control system include wherein the plurality of factors comprises a velocity of the vehicle.

Aspects of the above climate control system include wherein the instructions further cause the processor to determine a clothing insulation factor for the user and wherein calculating the equivalent temperature for each of the plurality of zones inside of the vehicle is further based on the clothing insulation factor.

Aspects of the above climate control system include wherein the instructions further cause the processor to: detect a request to change the thermal environment inside the vehicle, the request comprising feedback on the calculated equivalent temperature in relative terms or a change to the calculated equivalent temperature in relative terms; calculate a new equivalent temperature for each of the plurality of zones inside of the vehicle based on current values for the plurality of factors and the request to change the thermal environment inside the vehicle; and control the HVAC system of the vehicle based on the calculated new equivalent temperatures for each of the plurality of zones inside of the vehicle.

Aspects of the above climate control system include wherein the instructions further cause the processor to identify the user and wherein calculating the equivalent temperature for each of the plurality of zones inside of the vehicle is based on a profile for the identified user.

Aspects of the above climate control system include wherein the instructions further cause the processor to: save the calculated equivalent temperature and the plurality of factors upon which it is based in the profile for the identified user; and update the profile for the identified user with the new equivalent temperatures and the current values for the plurality of factors upon which it is based.

Embodiments include a vehicle comprising: a plurality of sensors, each sensor detecting one of a plurality of factors influencing the thermal environment inside the vehicle; a Heating, Ventilation, and Air Conditioning (HVAC) system; a climate control system coupled with each of the plurality of sensors and the HVAC system, the climate control system comprising: a processor; and a memory coupled with and readable by the processor and storing therein a set of instructions which, when executed by the processor, cause the processor to control a thermal environment inside the vehicle by: determining the plurality of factors influencing the thermal environment inside of the vehicle; calculating an equivalent temperature for each of a plurality of zones inside of the vehicle based on the plurality of factors, each equivalent temperature comprising an indication of a user's perception of the thermal environment at each of the plurality of zones inside of the vehicle; and controlling the HVAC system of the vehicle based on the calculated equivalent temperatures for each of the plurality of zones inside of the vehicle.

Aspects of the above vehicle include wherein the plurality of factors comprises an ambient temperature inside of the vehicle and an ambient temperature outside of the vehicle and the plurality of sensors comprise a plurality of ambient air temperature sensors at each of a plurality of locations within the vehicle.

Aspects of the above vehicle include wherein the plurality of factors comprises a radiant temperature on one or more surfaces on the inside of the vehicle and the plurality of sensors comprise one or more solar sensors

Aspects of the above vehicle include wherein the instructions further cause the processor to: detect a request to change the thermal environment inside the vehicle, the request comprising feedback on the calculated equivalent temperature in relative terms or a change to the calculated equivalent temperature in relative terms; calculate a new equivalent temperature for each of the plurality of zones inside of the vehicle based on current values for the plurality of factors and the request to change the thermal environment inside the vehicle; and control the HVAC system of the vehicle based on the calculated new equivalent temperatures for each of the plurality of zones inside of the vehicle.

Any of the steps, functions, and operations discussed herein can be performed continuously and automatically.

The exemplary systems and methods of this disclosure have been described in relation to vehicle systems and electric vehicles. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

While the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, sub-combinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

Any one or more of the aspects/embodiments as substantially disclosed herein.

Any one or more of the aspects/embodiments as substantially disclosed herein optionally in combination with any one or more other aspects/embodiments as substantially disclosed herein.

One or more means adapted to perform any one or more of the above aspects/embodiments as substantially disclosed herein.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “electric vehicle” (EV), also referred to herein as an electric drive vehicle, may use one or more electric motors or traction motors for propulsion. An electric vehicle may be powered through a collector system by electricity from off-vehicle sources, or may be self-contained with a battery or generator to convert fuel to electricity. An electric vehicle generally includes a rechargeable electricity storage system (RESS) (also called Full Electric Vehicles (FEV)). Power storage methods may include: chemical energy stored on the vehicle in on-board batteries (e.g., battery electric vehicle or BEV), on board kinetic energy storage (e.g., flywheels), and/or static energy (e.g., by on-board double-layer capacitors). Batteries, electric double-layer capacitors, and flywheel energy storage may be forms of rechargeable on-board electrical storage.

The term “hybrid electric vehicle” refers to a vehicle that may combine a conventional (usually fossil fuel-powered) powertrain with some form of electric propulsion. Most hybrid electric vehicles combine a conventional internal combustion engine (ICE) propulsion system with an electric propulsion system (hybrid vehicle drivetrain). In parallel hybrids, the ICE and the electric motor are both connected to the mechanical transmission and can simultaneously transmit power to drive the wheels, usually through a conventional transmission. In series hybrids, only the electric motor drives the drivetrain, and a smaller ICE works as a generator to power the electric motor or to recharge the batteries. Power-split hybrids combine series and parallel characteristics. A full hybrid, sometimes also called a strong hybrid, is a vehicle that can run on just the engine, just the batteries, or a combination of both. A mid hybrid is a vehicle that cannot be driven solely on its electric motor, because the electric motor does not have enough power to propel the vehicle on its own.

The term “rechargeable electric vehicle” or “REV” refers to a vehicle with on board rechargeable energy storage, including electric vehicles and hybrid electric vehicles.

What is claimed is:

1. A method for controlling a thermal environment inside of a vehicle, the method comprising:
determining, by a processor of a climate control system of the vehicle, a plurality of factors influencing the thermal environment inside of the vehicle;
calculating, by the processor of the climate control system, an equivalent temperature for each of a plurality of zones inside of the vehicle based on the plurality of factors, each equivalent temperature comprising an indication of a user's perception of the thermal environment at each of the plurality of zones inside of the vehicle; and
controlling, by the processor of the climate control system, a Heating, Ventilation, and Air Conditioning (HVAC) system of the vehicle based on the calculated equivalent temperatures for each of the plurality of zones inside of the vehicle.

2. The method of claim 1, wherein the plurality of factors comprises an ambient temperature inside of the vehicle measured at each of a plurality of locations within the vehicle and an ambient temperature outside of the vehicle and wherein the inside of the vehicle comprises a passenger cabin of the vehicle.

3. The method of claim 1, wherein the plurality of factors comprises a radiant temperature measured on one or more surfaces on the inside of the vehicle.

4. The method of claim 1, wherein the plurality of factors comprises a velocity of the vehicle.

5. The method of claim 1, further comprising determining a clothing insulation factor for the user and wherein calculating the equivalent temperature for each of the plurality of zones inside of the vehicle is further based on the clothing insulation factor.

6. The method of claim 1, further comprising:
detecting, by the processor of the climate control system, a request to change the thermal environment inside the vehicle, the request comprising feedback on the calculated equivalent temperature in relative terms or a change to the calculated equivalent temperature in relative terms;
calculating, by the processor of the climate control system, a new equivalent temperature for each of the plurality of zones inside of the vehicle based on current values for the plurality of factors and the request to change the thermal environment inside the vehicle; and
controlling, by the processor of the climate control system, the HVAC system of the vehicle based on the calculated new equivalent temperatures for each of the plurality of zones inside of the vehicle.

7. The method of claim 6, further comprising identifying, by the processor of the climate control system, the user and wherein calculating the equivalent temperature for each of the plurality of zones inside of the vehicle is based on a profile for the identified user.

8. The method of claim 7, further comprising:
saving, by the processor of the climate control system, the calculated equivalent temperature and the plurality of factors upon which it is based in the profile for the identified user; and
updating, by the processor of the climate control system, the profile for the identified user with the new equivalent temperatures and the current values for the plurality of factors upon which it is based.

9. A climate control system of a vehicle, the climate control system comprising:
a processor; and
a memory, coupled with and readable by the processor and storing therein a set of instructions which, when executed by the processor, cause the processor to control a thermal environment inside the vehicle by:
determining a plurality of factors influencing the thermal environment inside of the vehicle;
calculating an equivalent temperature for each of a plurality of zones inside of the vehicle based on the plurality of factors, each equivalent temperature comprising an indication of a user's perception of the thermal environment at each of the plurality of zones inside of the vehicle; and
controlling a Heating, Ventilation, and Air Conditioning (HVAC) system of the vehicle based on the calculated equivalent temperatures for each of the plurality of zones inside of the vehicle.

10. The climate control system of claim 9, wherein the plurality of factors comprises an ambient temperature inside of the vehicle measured at each of a plurality of locations within the vehicle and an ambient temperature outside of the vehicle.

11. The climate control system of claim 9, wherein the plurality of factors comprises a radiant temperature measured on one or more surfaces on the inside of the vehicle and wherein the inside of the vehicle comprises a passenger cabin of the vehicle.

12. The climate control system of claim 9, wherein the plurality of factors comprises a velocity of the vehicle.

13. The climate control system of claim 9, wherein the instructions further cause the processor to determine a clothing insulation factor for the user and wherein calculating the equivalent temperature for each of the plurality of zones inside of the vehicle is further based on the clothing insulation factor.

14. The climate control system of claim 9, wherein the instructions further cause the processor to:
detect a request to change the thermal environment inside the vehicle, the request comprising feedback on the calculated equivalent temperature in relative terms or a change to the calculated equivalent temperature in relative terms;
calculate a new equivalent temperature for each of the plurality of zones inside of the vehicle based on current values for the plurality of factors and the request to change the thermal environment inside the vehicle; and
control the HVAC system of the vehicle based on the calculated new equivalent temperatures for each of the plurality of zones inside of the vehicle.

15. The climate control system of claim 14, wherein the instructions further cause the processor to identify the user and wherein calculating the equivalent temperature for each of the plurality of zones inside of the vehicle is based on a profile for the identified user.

16. The climate control system of claim 15, wherein the instructions further cause the processor to:
save the calculated equivalent temperature and the plurality of factors upon which it is based in the profile for the identified user; and
update the profile for the identified user with the new equivalent temperatures and the current values for the plurality of factors upon which it is based.

17. A vehicle comprising:
a plurality of sensors, each sensor detecting one of a plurality of factors influencing the thermal environment inside the vehicle;
a Heating, Ventilation, and Air Conditioning (HVAC) system;
a climate control system coupled with each of the plurality of sensors and the HVAC system, the climate control system comprising:
a processor; and
a memory coupled with and readable by the processor and storing therein a set of instructions which, when executed by the processor, cause the processor to control a thermal environment inside the vehicle by:
determining the plurality of factors influencing the thermal environment inside of the vehicle;
calculating an equivalent temperature for each of a plurality of zones inside of the vehicle based on the plurality of factors, each equivalent temperature comprising an indication of a user's perception of the thermal environment at each of the plurality of zones inside of the vehicle; and
controlling the HVAC system of the vehicle based on the calculated equivalent temperatures for each of the plurality of zones inside of the vehicle.

18. The vehicle of claim 17, wherein the plurality of factors comprises an ambient temperature inside of the vehicle and an ambient temperature outside of the vehicle and the plurality of sensors comprise a plurality of ambient air temperature sensors at each of a plurality of locations within the vehicle.

19. The vehicle of claim 17, wherein the plurality of factors comprises a radiant temperature on one or more surfaces on the inside of the vehicle and the plurality of sensors comprise one or more solar sensors.

20. The vehicle of claim 17, wherein the inside of the vehicle comprises a passenger cabin of the vehicle and wherein the instructions further cause the processor to:
detect a request to change the thermal environment inside the vehicle, the request comprising feedback on the calculated equivalent temperature in relative terms or a change to the calculated equivalent temperature in relative terms;
calculate a new equivalent temperature for each of the plurality of zones inside of the vehicle based on current values for the plurality of factors and the request to change the thermal environment inside the vehicle; and
control the HVAC system of the vehicle based on the calculated new equivalent temperatures for each of the plurality of zones inside of the vehicle.
